(19) United States
(12) Patent Application Publication
(10) Pub. No.: US 2018/0077125 A1
(43) Pub. Date: Mar. 15, 2018

(54) METHOD AND SYSTEM FOR SECURELY SHARING CONTENT

(71) Applicant: Quirklogic, Inc., Calgary (CA)

(72) Inventor: Gorden Dean Elhard, Calgary (CA)

(21) Appl. No.: 15/260,940

(22) Filed: Sep. 9, 2016

(51) Int. Cl. H04L 29/06; H04L 9/32; H04L 9/14; H04L 9/30; G06F 17/30

(52) U.S. Cl. CPC H04L 63/0435; H04L 9/3242; G06F 17/30088; H04L 9/30; H04L 9/14

(57) ABSTRACT

A system and method for managing files. The method includes sending by a user, to a server, a request for a file, receiving, in response to the request, an encrypted file and an encrypted file key associated with the file and the user, decrypting the encrypted file key using a private key associated with the user to obtain a symmetric key, and decrypting the encrypted file using the symmetric key to obtain the file. The files being managed are server resident files for any number of users, where the server is unable to encode or decode file data associated with the server resident files.

### BACKGROUND

Many projects are team-based and often require the collaboration of multiple people, who may or may not be in the same geographic location. In light of this, there has been a growing need for a collaborative framework that allows users to collaborate on documents and other projects, without regard to where they are. The current approach to document collaboration utilizes a cloud-based model or centralized server to store a document created directly within, or uploaded to, the server. While this approach allows for document collaboration, it also introduces various security risks, some of which have not been adequately addressed. For example, although some cloud-based servers secure the network connection between the server and the device accessing the server, the user's content is often stored on the server in plain text.

In such scenarios, if the hosting server is compromised, then all of the files on the server may also be compromised. Additionally, if a user logs into the server from a non-personal device and forgets to log out, or if the user fails to remove a file downloaded to the non-personal device, an unauthorized person may obtain access to the file. As such, the aforementioned approach is not as secure as an approach that utilizes multiple decentralized layers of security to ensure the confidentiality and integrity of a file, whether it is stored remotely or has been downloaded to a local device.

### SUMMARY

In general, in one aspect of the invention, the invention relates to a method for securely creating and sharing content using a non-personal device, a personal device, and a remote server. The method includes sending by a user, to a server, a request for a file, receiving, in response to the request, an encrypted file and an encrypted symmetric key associated with the file and the user, decrypting the encrypted symmetric key using a private key associated with the user to obtain a symmetric key, and decrypting the encrypted file using the symmetric key to obtain the file. The files being managed are server resident files for any number of users, wherein the server is unable to encode or decode file data associated with the server resident files.

In general, in one aspect of the invention, the invention relates to a non-transitory computer readable medium, which when executed by a processor, performs a method to facilitate the secure sharing of content. The method for managing server resident files for any number of users in which the file data is secure from the server itself includes sending by a user, to a server, a request for a file, receiving, in response to the request, an encrypted file and an encrypted symmetric key uniquely associated with the file and the user, decrypting the encrypted symmetric key using a private key associated with the user to obtain a symmetric key; and decrypting the encrypted file using the symmetric key to obtain the file. The files being managed are server resident files for any number of users, wherein the server is unable to encode or decode file data associated with the server resident files.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows relationships between various components of the system in accordance with one or more embodiments of the invention.

FIG. 3 shows a method for adding an authorized user in accordance with one or more embodiments of the invention.

FIGS. 4A-4C shows a method for creating and updating files in accordance with one or more embodiments of the invention.

FIG. 5 shows a method for accessing stored files in accordance with one or more embodiments of the invention.

FIG. 6 shows a method for granting access to stored files in accordance with one or more embodiments of the invention.

FIG. 7 shows an example in accordance with one or more embodiments of the invention.

### DETAILED DESCRIPTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

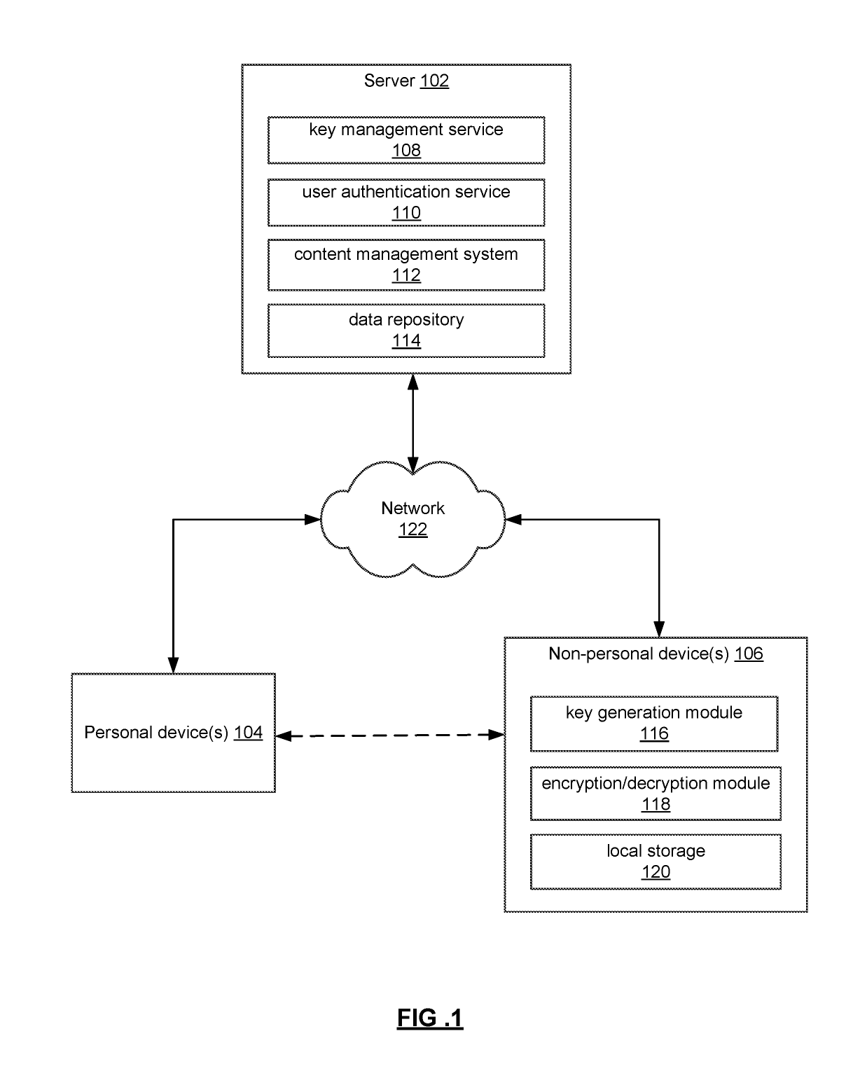

In the following description of FIGS. 1-7, any components described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

In general, embodiments of the invention relate to a method and system for securely sharing content between a remote server, a personal device, and a non-personal device. More specifically, embodiments of the invention utilize virtual encryption keys to facilitate the secure storage and management of files created on one or more non-personal devices, as well as the secure access and collaboration of the files by one or more authorized users.

In one or more embodiments of the invention, the system includes at least one non-personal device connected to a remote server and capable of bi-directional transmission of certain information through a secured network connection. The system may also include, in one or more embodiments, at least one personal device connected to the remote server and/or to the non-personal device. Additionally, aside from the aforementioned secured network connection, which transmits the information as packets and secures information in the aggregate, certain transmitted information within the packet is also encrypted, using multiple layers, at the individual file or content level. Because embodiments of the invention utilize this multi-level encryption approach, embodiments of the invention both enable the secure transmission of the information between the system components and preserve the integrity and confidentiality of the information while it is stored on the remote server and the non-personal device.

FIG. 1 shows a system that includes a server (102), a personal device (104), a non-personal device (106), and a network (122). Each of the aforementioned components is described below.

In one or more embodiments of the invention, the server (102) may be any computing system capable of storing content securely. In one or more embodiments, the server (102) includes a key management service (108), a user authentication service (110), a content management system (112), a data repository (114), and a processor (not shown). For example, the server (102) may be a virtual server or a physical server appliance. The server may also, in one or more embodiments, be a storage facility in a cloud computing environment.

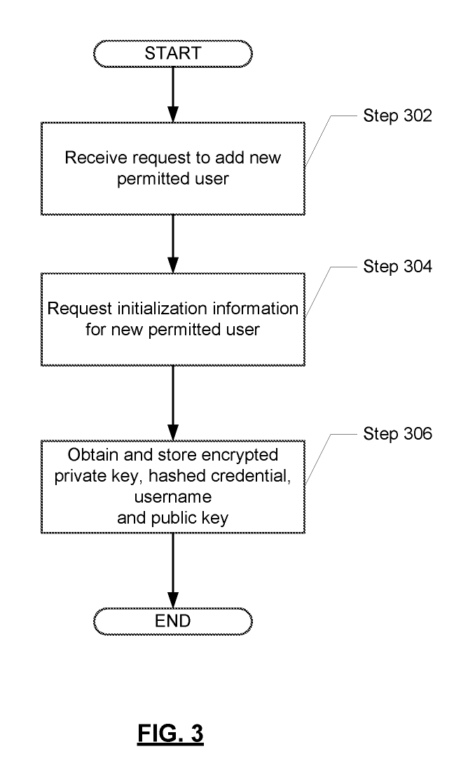

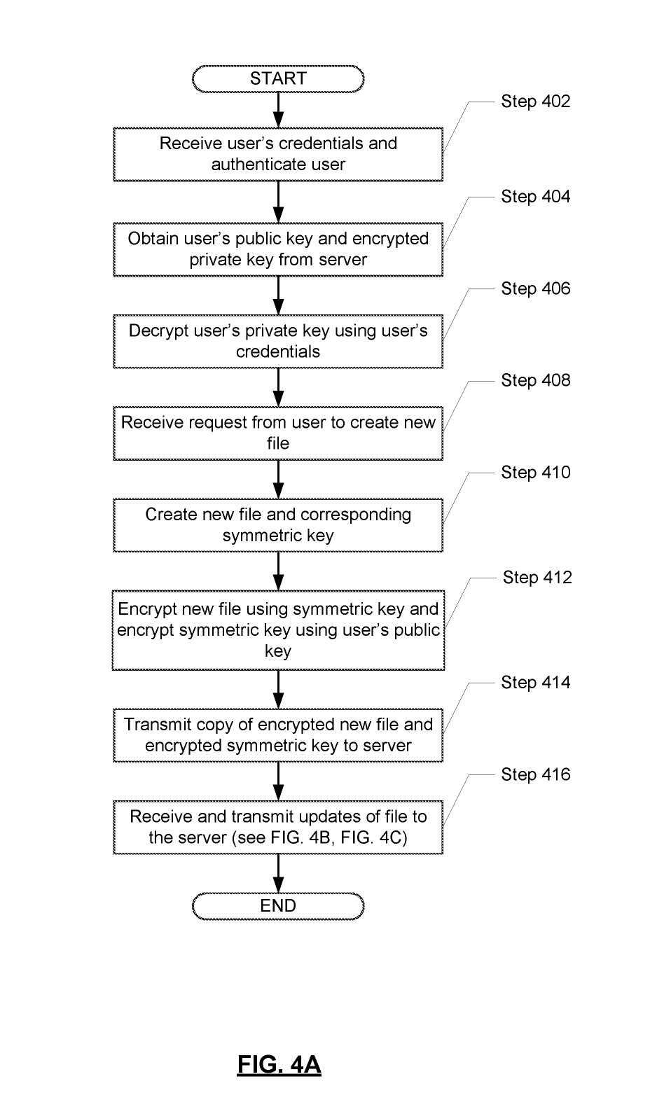

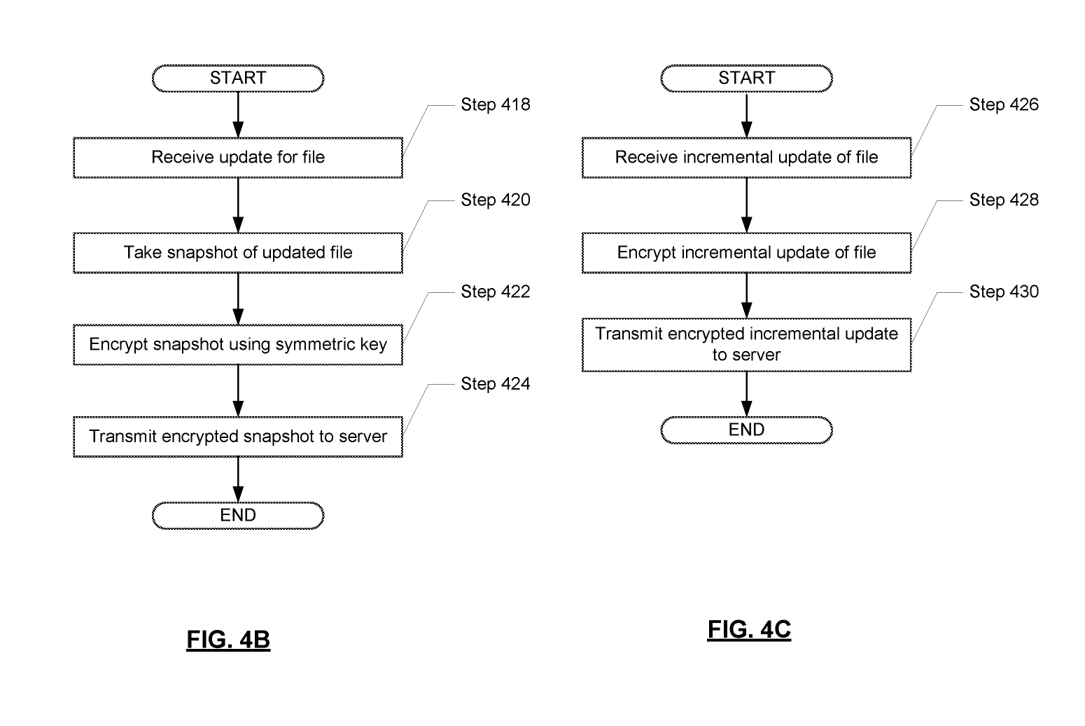

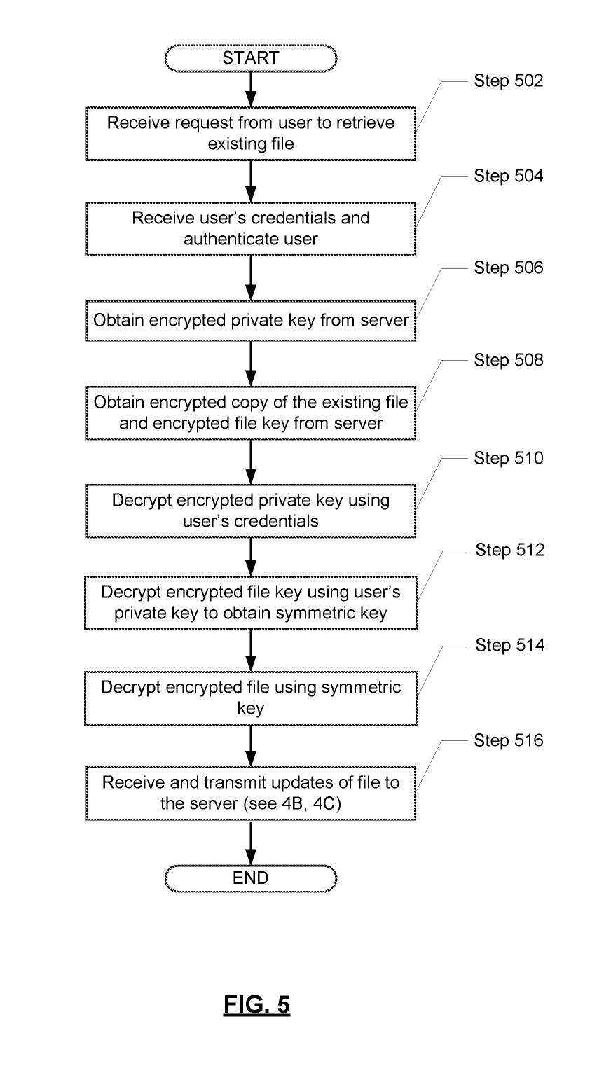

In one or more embodiments of the invention, the server (102) includes functionality, via the processor, to receive a request to add a new authorized user of the system, request and obtain initialization information related to the user, and store the initialization information in the data repository (114), in accordance with the embodiments shown in FIG. 3. Furthermore, in one or more embodiments of the invention, the server (102) is configured to send and receive information, such as encrypted encryption keys, user authentication credentials and encrypted file content and updates, to and from the non-personal device (106), in accordance with the embodiments shown in FIGS. 4-6. In one or more embodiments of the invention, the server (102) may also be configured to receive encrypted encryption keys and user authentication credentials directly from the personal device (104). As the server does not see any non-encrypted encryption keys, at no time is the server able to encode or decode the file data. Additionally, the server (102) is configured to manage the aforementioned information using the key management service (108), the user authentication service (110), and the content management system (112).

In one or more embodiments of the invention, the key management service (108) is any computer service, module, application, or device, operatively connected to the server (102), and configured to administer and store encrypted cryptographic keys received from the personal device (104) and/or the non-personal device (106). For example, the key management service (108) may be a service included within the operating system of the server (102). Further, the key management service (108) includes key management security policies that specify how the encrypted cryptographic keys and any corresponding metadata are protected and stored on the server (102). An example key management security policy may specify how long a cryptographic key should be stored on the server (102). Additionally, in one or more embodiments of the invention, the key management security policy may be encoded within, and automatically enforced by, the key management service (108).

In one or more embodiments of the invention, the user authentication service (110) is any computer service, module, application or device, operatively connected to the server (102), that is configured to authenticate a user of the system. The user authentication service (110) may be used to verify that a user is an authorized user of the server, and more specifically, of the content stored on the server. Additionally, the user authentication service (110) may be used to verify that an authorized user requesting a file from the server (102), is also a permitted user of the file requested. In one or more embodiments of the invention, the user authentication service (110) may authenticate a user of a non-personal device (106) to the server (102) using a hashed user credential (discussed below). For example, the user authentication service (110) may compare a hashed user credential stored on the server (102) with a hashed user credential generated by the non-personal device (106), to ensure that the two hashed user credentials match. The user authentication service may use the server processor (not shown) to perform authentication functionalities.

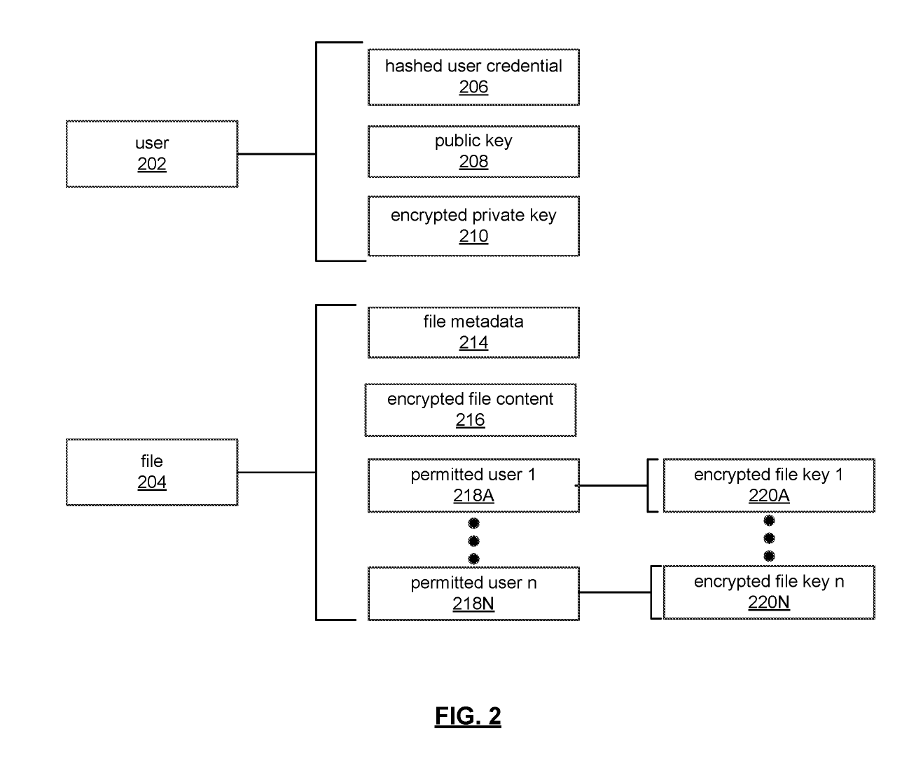

In one or more embodiments of the invention, the content management system (112) is any computer service, module, application, or device, operatively connected to the server, that is configured to manage the information workflow related to file content stored in the data repository (114). For example, the content management system (112) may be a server application that publishes, formats, indexes, searches and retrieves non-encrypted content stored on the server (102). As noted above, the server cannot publish, format, index, or search encrypted content, but rather, is only able to retrieve such encrypted content upon request. Additionally, the content management system (112) may provide version control of multiple versions of and updates to content. In one or more embodiments of the invention, the content management system is configured to manage and track file metadata for each file stored in the data repository (114), encrypted file content, permitted users of the file and encrypted file keys associated with those permitted users, in accordance with the embodiments shown in FIG. 2 discussed below. Additionally, the content management system (112) is configured to facilitate the retrieval of files by the server (102), from the data repository (114), using the aforementioned information related to the files.

In one or more embodiments of the invention, the data repository (114) is any location (or set of locations), within or operatively connected to, the server (102), that includes the functionality to store data. In one or more embodiments of the invention, the data repository (114) includes the functionality to store encrypted and unencrypted user and file data, as shown in FIG. 2 discussed below. In addition, the data repository is also configured to store encryption keys associated with the files.

Continuing with FIG. 1, in one or more embodiments of the invention, the non-personal device (106) is any computing system that is a public device. That is, the non-personal device (106) is not owned by a permitted user requesting access to or creating new files that are stored on the server (permitted users are discussed in more detail below), and may be available for use by a group of users or even the general public. In one or more embodiments, there may be more than one non-personal device (106) with which a permitted user interacts. The non-personal device (106) may include a key generation module (116), an encryption/decryption module (118), and local storage (120). The non-personal device (106) may also include a processor (not shown) to facilitate the processing of the information used by the key generation module (116) and the encryption module (118), and a user interface (not shown), to facilitate the input, manipulation, transmission and storage of information processed by the processor. For example, the non-personal device (106) may be a desktop computer, a laptop, a tablet, an electronic presentation device (such as an interactive whiteboard or e-reader device), or any other similar computing system.

In one or more embodiments of the invention, the key generation module (116) is any computer service, module, application or device that is configured to generate, exchange, store, use, and track cryptographic keys. The key generation module (116) may be integrated within, or operatively connected to, the non-personal device (106). Additionally, the type of cryptographic keys that the key generation module (116) is configured to generate, exchange, store, use and track may be symmetric encryption keys, asymmetric public and private key pairs, or both. In one or more embodiments of the invention, the key generation module (116) is configured to generate a corresponding symmetric encryption key for each file created by a user of the non-personal device (106), in accordance with the embodiments shown in FIG. 4A. Further, in one or more embodiments of the invention, the key generation module (116) is configured to transmit the generated symmetric encryption keys to the encryption/decryption module (118) for further processing, as discussed below.

In one or more embodiments of the invention, the encryption/decryption module (118) is any computer service, module, application, or device that is configured to encode and decode the cryptographic keys generated by and received from the key generation module (116), the server (102) and/or the personal device (104). The encryption/decryption module (118) may be integrated within, or operatively connected to, the non-personal device (106).

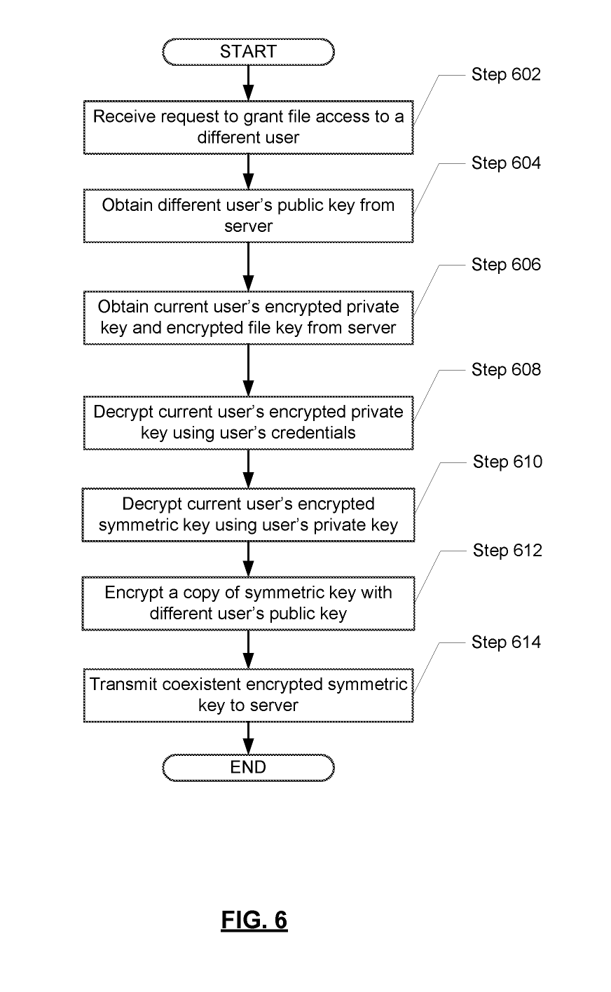

In one or more embodiments of then invention, the encryption/decryption module (118) is configured to encode a file corresponding symmetric key generated by the key generation module (116), before the file is transmitted to the server (102), in accordance with embodiments shown in FIG. 4A. The encryption/decryption module (118) is also configured to encode any updates made to the file, either in increments or complete snapshots, after the file's initial submission to the server (102), in accordance with embodiments shown in FIGS. 4B-4C. Further, in one or more embodiments of the invention, the encryption/decryption module (118) is configured to encode the file's symmetric key with a permitted user's (discussed below) public key before the symmetric key is transmitted to the server (102), in accordance with embodiments shown in FIGS. 4A and 6. Additionally, in one or more embodiments of the invention, the encryption/decryption module (118) is also configured to decode a permitted user's private key using the user's private credentials, decode a file's symmetric key using the permitted user's decoded private key, and decode the file using the decoded symmetric key, in accordance with the embodiments shown in FIGS. 5-6.

In one or more embodiments of the invention, the local storage (120) is any digital repository located within the non-personal device (120) that includes the functionality to store data. For example, the local storage (120) may be an integrated hard drive, non-volatile memory, and or volatile memory located with the non-personal device (106). In one or more embodiments of the invention, the local storage (120) includes the functionality to temporarily store encrypted and unencrypted file and user data generated by the non-personal device (106) or obtained from the personal device (104) and/or the server (102).

Further continuing with FIG. 1, in one or more embodiments of the invention, the personal device (104) is any personally-owned computing system that includes a network connection interface (not shown), local persistent memory (not shown), and a processor (not shown). The personal device (104) may also include a user interface (not shown), to facilitate the input, manipulation, transmission and storage of information processed by the processor. For example, the personal device (104) may be a laptop, a smartphone, a tablet, an electronic presentation device, or any other similar computing system that may be owned by the permitted user (discussed below). Further, there may be multiple personal devices (104) owned by the permitted user. Additionally, the network connection interface may be wired or wireless. For example, the network connection interface may be a Bluetooth interface, a near field communications (NFC) interface, or a wireless Local Area Network (LAN) interface.

In one or more embodiments of the invention, the personal device (104) is configured to store a user's credentials in the local persistent memory. The personal device (104) is also configured to transmit the user credentials to the non-personal device (106) using a wireless connection. For example, in one or more embodiments of the invention, the personal device (104) is configured to transmit, or to initiate the transmission through another communication mechanism, of the user's credentials to the non-personal device (106) using a near field communications (NFC) channel.

The network (122) may be any network which the non-personal device (106), the server (102), and the personal device (104) use to communicate. For example, the network (122) may be any wired or wireless network, e.g., a local area network (LAN), a wide area network (WAN) such as the Internet, mobile network, or any other suitable type of network.

While FIG. 1 shows a configuration of components, system configurations other than those shown in FIG. 1 may be used without departing from the scope of the invention. For example, various components may be combined to create a single component. As another example, the functionality performed by a single component may be performed by two or more components.

Turning to FIG. 2, FIG. 2 shows data structures that illustrate the relationships between certain data managed by components of the server (102), in accordance with one or more embodiments of the invention. The data structures include user (202) and file (204) relationships. Each of the aforementioned elements is described below.

In one or more embodiments of the invention, the user (202) data structure includes data pertaining to one or more user(s) (202) of the system. The user (202) data is associated with particular permitted users of the system and includes a hashed user credential (206), a public key (208), and an encrypted private key (210) for each permitted user. In one or more embodiments of the invention, the hashed user credential (206) is a message digest (hash) of a user's credential using a hash function. As previously discussed, the user's credential may be a password, passkey, or similar credential. Further, in one or more embodiments of the invention, the hashed user credential is transmitted to the server that stores the files by the personal device of the permitted user. The public key (208) and the encrypted private key (210) are corresponding cryptographic (encryption) key pairs. In one or more embodiments of the invention, the public key and encrypted private key is managed by the user authentication service described in FIG. 1.

In one or more embodiments of the invention, the file (204) data structure includes data pertaining to one or more file(s) (204) created by a user of the system. The file (204) data is associated with a particular file stored in the data repository (114) and includes file metadata (214), encrypted file content (216), at least one permitted user (218A-218N), and at least one encrypted file key (220A-220N). In one or more embodiments of the invention, the file metadata (214) may include information such as a name of the file, a name of a user that created the file, a file creation date and time stamp and a modification date and time stamp. The file metadata may be used by the content management system (112 in FIG. 1) to manage the encrypted file content (216), as previously discussed above. In one or more embodiments of the invention, the encrypted file content (216) is the actual file content (as opposed to file metadata) created by a permitted user (218A-218N) of the file (discussed below). For example, the encrypted file content may include full snapshots of file content originally created or updated by a permitted user (218A-218N), or it may include incremental updates made to a file, in accordance with the embodiments shown in FIGS. 4B-4C. Further, the encrypted file content (216) may be encrypted with the corresponding symmetric key generated by the key generation module (116 in FIG. 1), as previously discussed above.

In one or more embodiments of the invention, the permitted user (218A-218N) is a user (202) of the system that has authority to access to a particular file. The permitted users (218) may include the original creator of the file (204), as well as any users (202) that have been granted authority to access the file (204), in accordance with the embodiments shown in FIG. 6. For example, the file (204) in FIG. 2 may be associated with multiple permitted users, as denoted by permitted user 1 (218A) through permitted user n (218N). As such, there may exist, for example, a permitted user 1 (218A), a permitted user 2 (218 B) and a permitted user 3 (218C), all of which have the authority to access file (204).

Further, in one or more embodiments of the invention, each permitted user (218) is uniquely associated with an encrypted file key (220A-220N). The encrypted file key (220A-220N) is the corresponding symmetric key of the file, which has been encrypted using the public key (208) of a particular permitted user (218A-218N), in accordance with the embodiments shown in FIG. 4A and FIG. 6. For example, permitted user 1 (218A) may be associated with encrypted file key 1 (220A), user 2 may be associated with encrypted file key 2 (220B) and user 3 may be associated with encrypted file key 3 (220C). Those skilled in the art will appreciate that, because a file's symmetric key is uniquely encrypted with a particular user's public key (208), a file may be downloaded to a device by someone logged into the device as a permitted user (218A-218N), however the file may not be accessed unless the user also possesses the necessary private key to decrypt the file's symmetric key.

FIGS. 3-6 show flowcharts in accordance with one or more embodiments of the invention. While the various steps in each flowchart are presented and described sequentially, one of ordinary skill in the art will appreciate that some or all of the steps may be executed in different orders, may be combined or omitted, and/or may be executed in parallel. In one embodiment of the invention, one or more steps shown in FIGS. 3-6 may be performed in parallel with one or more other steps shown in FIGS. 3-6.

FIG. 3 shows a flowchart for adding a permitted user in accordance with one or more embodiments of the invention. The process shown in FIG. 3 is performed from the perspective of the server in the system.

In step 302, a request to add a new permitted user is received. The request may be received from an existing permitted user or from a service of the server. For example, the request may be received from an administrator of the server. As another example, the request may be triggered by an update to a local or remote user directory service, such as Active Directory.

In step 304, a request for initialization information is generated in response to the request to add a new permitted user. The initialization information may be requested from the existing permitted user or service that originally requested the addition of the new permitted user, or it may be requested from an permitted user or service that is different from the original requester. For example, in response to a new user request made by an administrator of the server, an initialization information request may be sent to the user directory service in order to verify and/or obtain certain initialization information related to the new user.

In step 306, the server obtains the initialization information associated with the new user, including: a username, a hashed credential, a public key, and an encrypted private key. As previously discussed, in one or more embodiments of the invention, the hashed credential may be any password, passkey, or similar credential that is linked to the user, for the purpose of remotely authenticating the user to the server. The password, passkey, or similar credential is provided to the server in hashed form (i.e., not in clear form as recognizable alphanumeric characters, etc.). In this manner, the server does not have access to the user's password/passkey in clear form. In one or more embodiments, the clear form of the user's password/passkey is only provided on the non-personal device when it is entered by the user.

Further, the username may be any unique identifier of the user. For example, the username may be an email address or a user's employee number or computer login name (e.g., some combination of the user's first name and last name). The user's private credentials may consist of the user's username and a password, passkey, or passphrase that is known only to the user. In one or more embodiments of the invention, the user's public key and encrypted private key may be generated on the user's smartphone, for example, and may be subsequently transmitted to the server. In such an embodiment, the user's public and private keys may be originally obtained by the server from the non-personal device. In this way, the server does not ever create or know the user's private key. In an alternate embodiment, the server may generate the user's private key initially (as well as the public key), and then discard or otherwise forget the unencrypted version of the user's private key. The user's public and private keys are typically mathematical constructs. For example, the public and private keys may each be a different set of alphanumeric or numeric characters, generated by a suitable computing device. Upon obtaining the initialization information for the new user, the server stores the initialization information into the data repository (114). The user is now initialized and authorized to create content and collaborate through the server (102).

FIGS. 4A-4C shows flowcharts for creating and updating files in accordance with one or more embodiments of the invention. The processes shown in 4A-4C are performed from the perspective of the non-personal device in the system.

FIG. 4A shows a flowchart for creating a file in accordance with one or more embodiments of the invention. Specifically, FIG. 4A shows a process for an initialized user (using the steps of FIG. 3) to create secure content that is stored in the form of a file on the server.

In step 402, the non-personal device receives a login request from a user seeking access to the non-personal device. For example, the user may input a username and password (in clear form) into the non-personal device to log into the non-personal device. The user may enter a username and password into the non-personal device using a keyboard, a mouse and/or a touch-screen user interface operatively connected to the non-personal device. Alternatively, in one or more embodiments, the user may use a personal device to provide a username and password or any other suitable login information to the non-personal device. This may be done, for example, using wireless connectively between the personal and non-personal device, which allows the personal device to transmit login information to the non-personal device. For example, the non-personal device may read an optical label displayed on a user interface of the user's personal device to obtain a username and password pair for the user and log the user into the non-personal device. Or, as another example, the user's personal device may read an optical label displayed on a non-personal device to obtain a private communication channel in which the user's personal device could pass the username and password pair for the user and then log the user into the non-personal device. As another example, the username and/or password may be wirelessly transmitted to the non-personal device from the user's mobile phone using near field communications technology.

Subsequently, the non-personal device authenticates the user using the username and hashed credential obtained from the server. Specifically, in one or more embodiments of the invention, the non-personal device may hash the user's password/passkey, provide the hashed user credential to the server, and then server may compare the hashed user credential received from the non-personal device to the one stored as part of the user data structure (206 in FIG. 2). If the two hashed user credentials match, the server may inform the non-personal device that the user is authenticated. Alternatively, in one or more embodiments, the non-personal device may locally authenticate the user by requesting the hashed user credential stored in the server, hashing the password/passkey input by the user at the time of login, and comparing the two data entities locally to authenticate the user.

In step 404, after the user has been successfully logged in and authenticated to the non-personal device, the user's public key and encrypted private key are obtained from the server and downloaded locally on the non-personal device. In step 406, the user's encrypted private key is decrypted using the user's authenticated credentials. Upon successful authentication of the user and the decryption of the user's private key credentials, the user may create and remotely share secure files.

In step 408, the authenticated user of the non-personal device requests the creation of a new file. The request may be made using the user interface of the non-personal device. For example, the user may simply begin writing or drawing on the interactive display screen of the non-personal device, thereby triggering the creation of a new file. Alternatively, the user may be prompted by the non-personal device to perform an action, one of which may be to create a new file. In step 410, the new file is created in response to the new file request. In addition to the creation of the new file, a corresponding symmetric key is also created using the key generation module, in order to encrypt the new file for secure transmission to, and storage within, the data repository of the server. Those skilled in the art would appreciate that every file created by the user is uniquely associated with and individually encrypted with a corresponding symmetric key.

In step 412, the new file is encrypted using the symmetric key. As another layer of security, the symmetric key used to encrypt the new file is encrypted using the user's public key. This encrypted symmetric key is known as the encrypted file key shown in FIG. 2 (220A-220N). In step 414, a copy of the file encrypted with the symmetric key, as well as the uniquely associated encrypted file key for the encrypted file, are transmitted to the server. In one or more embodiments of the invention, the encrypted file and the encrypted file key are separately transmitted to the server. In step 416, any updates or changes made to the encrypted file are received by the non-personal device and transmitted to the server for synchronization. In one or more embodiments of the invention, the file updates to the server may be made incrementally or using snapshots of a particular state, as illustrated in FIGS. 4B-4C and discussed below.

FIG. 4B shows a flowchart for updating snapshots of a file in accordance with one or more embodiments of the invention.

In step 418, the non-personal device receives an update to the file. An update may be any modification to an existing file and is made by a permitted user of the file. In step 420, a snapshot of the updated file, in its entirety, is taken. In one embodiment of the invention, a snapshot is a recordation of the entire state of the file at a particular time. The snapshot may be taken immediately upon receiving any modification to the file or it may be taken immediately upon receiving a specific type of file modification. For example, the snapshot may be taken immediately upon receiving a modification to the content of the file, but not immediately upon receiving a modification to the file metadata. In another embodiment of the invention, the snapshot may be taken at periodic intervals, without regard to the type of modification made to the file. In step 422, the snapshot is encrypted using the symmetric key associated with the file. In step 424, the snapshot is transmitted to the server and stored in the data repository. Those skilled in the art will appreciate that steps 418-424 of FIG. 4B may occur each time an update to a file is made.

FIG. 4C shows a flowchart for incrementally updating a file in accordance with one or more embodiments of the invention. Specifically, FIG. 4C shows, as an alternative to taking and uploading snapshots of a file as in FIG. 4B, storing updates to a file by transmitting increments of the modified data to the server.

In step 426, the non-personal device receives an incremental update to the file. In one or more embodiments of the invention, an incremental update is a recordation of only the portion of the file (as opposed the entire state as would be required for a file snapshot) that has been modified since the file was last updated. As with the snapshot update discussed above, the incremental update may be made immediately upon receiving any modification to the file or upon receiving a specific type of file modification. Further, the incremental update may be made at periodic intervals, without regard to the type of modification made to the file. In step 428, the incremental update of the file is encrypted using the symmetric key associated with the file. In step 430, the incremental update is transmitted to the server and stored in the data repository. Those skilled in the art will appreciate that steps 426-430 of FIG. 4C may occur each time an update to a file is made.

FIG. 5 shows a flowchart for retrieving an existing file from the server in accordance with one or more embodiments of the invention.

In step 502, the non-personal device receives a request from the user to retrieve an existing file that was created by the same permitted user. In step 504, the non-personal device authenticates the user using the username and hashed credential obtained from the server. As previously discussed above, in one or more embodiments of the invention, the user may be authenticated by comparing a username and credential supplied by the user to the hashed credential obtained from the server. The username and credential supplied by the user may be received via direct input by the user or it may be received indirectly via a user's personal device.

In step 506, upon successful authentication of the user, the user's encrypted private key is obtained from the server and downloaded locally on the non-personal device. In step 508, an encrypted copy of the requested existing file is obtained from the server data repository. Additionally, the encrypted file key associated with the requested file is also obtained from the server. As previously discussed, the symmetric key of a particular file is encrypted with the public key of the user requesting the particular file, resulting in the encrypted file key of a file. In step 510, the user's encrypted private key is decrypted using the user's authenticated credentials. In step 512, upon decryption of the user's private key, the encrypted file key associated with the requested file is decrypted using the user's private key. Decrypting the encrypted file key provides the symmetric key. In step 514, upon decryption of the encrypted file key, the file is decrypted using the symmetric key. After the three levels of decryption are performed in accordance with steps 510-514, the file is accessible to the permitted user.

In step 516, any updates or changes made to the file are received by the non-personal device and transmitted to the server for synchronization. As discussed above, in one or more embodiments of the invention, the file updates to the server may be made incrementally or using snapshots of a particular state, as illustrated in FIGS. 4B-4C.

FIG. 6 shows a flowchart for granting file access to a user that is different from the user that created the file. That is, FIG. 6 illustrates the scenario in which a first permitted user of a file requests the server to allow a second user to be a permitted user of the same file.

In one or more embodiments of the invention, access to a particular file may only be granted by the user that initially created the file or that otherwise has rights to grant access to the particular file. In step 602, the non-personal device receives a request from the current user to grant file access to a different user. In one or more embodiments of the invention, the current user is the initial creator of the requested file and is currently authenticated to the non-personal device, as described above and illustrated in steps 402-406 of FIG. 4.

In step 604, the different user's public key is obtained from the server, so that this public key may be used to encrypt the symmetric key of the requested file. In one embodiment of the invention, the different user has previously registered with the server in accordance with the method described in FIG. 3. In step 606, the non-personal device obtains the current user's encrypted private key and encrypted file key from the server. In step 608, the current user's encrypted private key is decrypted using the current user's credentials. In step 610, the current user's encrypted file key is decrypted using the current user's private key to obtain the symmetric key associated with the file. In step 612, a copy of the decrypted symmetric key is encrypted with the different user's public key, resulting in two symmetric keys for the file on the server. In step 614, the coexistent symmetric key encrypted with the different user's public key is transmitted to the server.

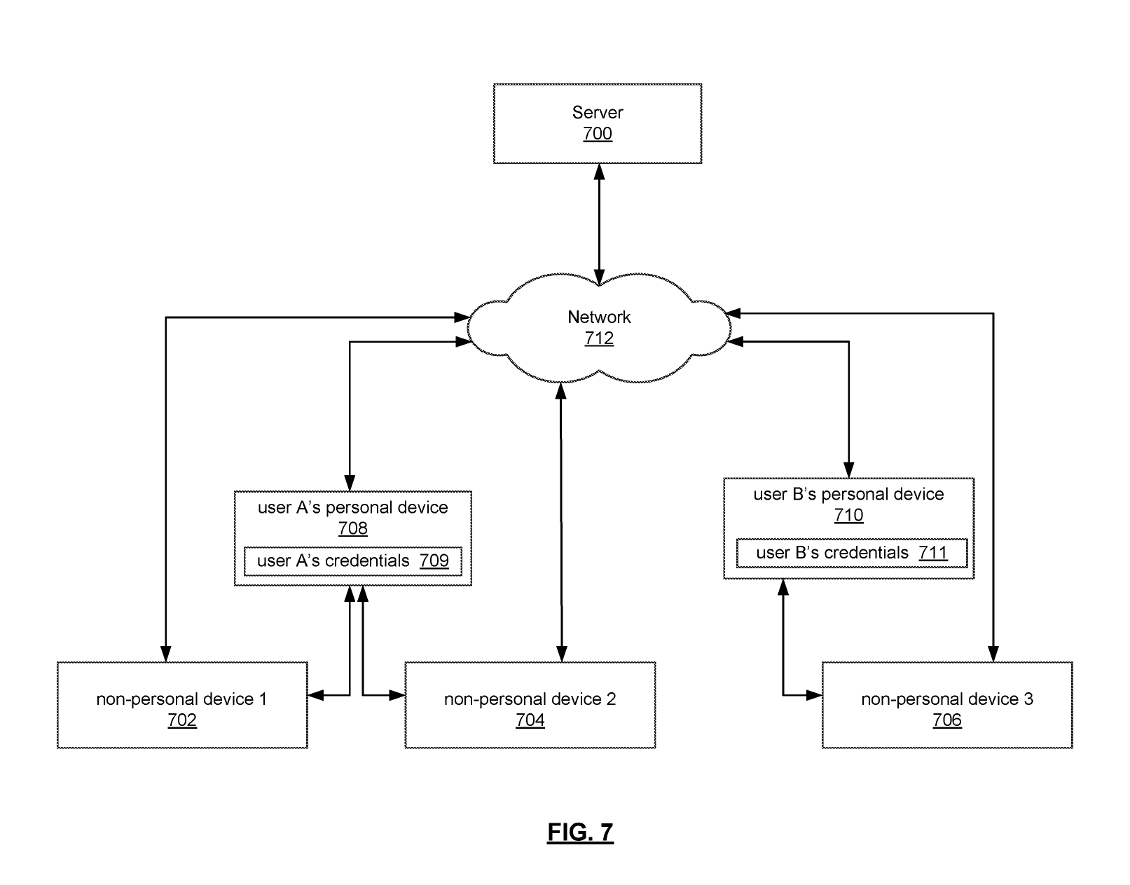

FIG. 7 shows an example in accordance with one or more embodiments of the invention. The example of FIG. 7 is for explanatory purposes only, and is not intended to limit the scope of the invention.

Consider a scenario in which there exists a first presenter (user A) and a second presenter (user B) that are giving a presentation in a rented conference room. The users both work for the same employer and the employer regularly rents the conference room to better accommodate its clients. To facilitate their presentation, the two users utilize three non-personal devices (702, 704, and 706) that are located in the front of a presentation room. The three non-personal devices (702, 704, and 706) are electronic flipcharts owned by the conference room provider and connected through a network connection. Additionally, the three non-personal devices (702, 704, and 706) include software that allows the users to log into the non-personal devices (702, 704, and 706) using their personal devices (708 and 710, respectively). By doing so, the users are able to authenticate to the non-personal device (702, 704, and 706) without permanently storing any login credentials (709, 711) on the non-personal device (702, 704, and 706). Further, the users are also able to authenticate to a remote server (700) using their personal devices (708, 710), in order to securely collaborate on their presentations.

Before the presentation starts, User A uses a personal device (708) that is a smartphone, tablet, or similar portable computing device, in order to log into the first electronic flipchart (non-personal device 1 (702)). User A taps the smartphone to the electronic flipchart, placing it in a proximity that transmits a signal to the smartphone and initiates a session login. The smartphone transmits User A's login credentials (709) stored on the personal device (708) to non-personal device 1's (702) volatile memory. Upon receipt of User A's login credentials (709), User A is authenticated to non-personal device 1 (702) and is now able to create new content or access existing content stored on the remote server (700) on Device 1 (702) using the processes described above in FIGS. 4A and 5, respectively. That is, the user's encrypted private key, public key, hashed credential, and username are generated and sent by non-personal device 1 (702) to the server (700) for storage in the data repository.

Suppose now that User A creates a new file on non-personal device 1 (702) to jot down any questions from the clients at the presentation. Before the file is transmitted to the server (700) via the network (712), non-personal device 1 (702) generates a symmetric key uniquely associated with the file and encrypts the file using the symmetric key. Additionally, non-personal device 1 (702) generates a public key using User A's username and a corresponding private key using User A's password. non-personal device 1 (702) encrypts the symmetric key with User A's public key. The encrypted file and the encrypted file key are both sent to the server (700) for storage in the data repository via network (712).

User A may periodically save the new file to the server (700) to ensure that it is continually updated as he writes. The file may be saved incrementally (FIG. 4C) or as snapshots (FIG. 4B).

Now suppose that User B retrieves a file for which he/she is a permitted user from the server (700) for display on non-personal device 2 (704), and he is going to present his file on the second non-personal device at the same presentation. User B would go through the same process of logging into non-personal device 2 (704) using User B's personal device (710) which stores User B's credentials, and being authenticated by a combination of non-personal device 2 (704) and the server (700). Upon successful authentication, User B is able to request an existing file from the server (700). User B's request would trigger non-personal device 2 (704) to obtain an encrypted copy of the requested file and the encrypted file key from the server (700). User B's encrypted private key is then decrypted using the user's unhashed credentials. The decrypted private key of User B is then used to decrypt the encrypted file key associated with both User B and the requested file. Once the file key is decrypted, the symmetric key is obtained, and the encrypted file with the content that User B wants to present is decrypted with the symmetric key.

At this point, User B is able to receive and transmit updates to the decrypted requested file and save any modifications to the server via the process of FIG. 4B (snapshots) or FIG. 4C (incrementally).

Once the presentation is underway, suppose that User A wants to grant access to the notes file created by User A to User B. Only User A is currently a permitted user for the notes file, because User A created the notes file on non-personal device 1 (702). In this case, User A may request the server to grant file access to the notes file to User B using the process of FIG. 6. Further, this may occur using non-personal device 3 (706), which both User A and User B are logged into.

Specifically, non-personal device 3 (706) obtains User B's public key from the server. User B's public key may be obtained from the login information that User B entered when User B logged into non-personal device 3 (706). Alternatively, User B's public key may already be stored in the server because of User B's interactions on non-personal device 2 (704). Subsequently, User A's encrypted private key and encrypted file key are obtained from the server onto non-personal device 3 (706). Then, User A's encrypted private key is decrypted using User A's credentials (709). The decrypted private key of User A is then used to decrypt User A's encrypted file key to obtain the symmetric key for the notes file. The notes file's symmetric key is then encrypted with User B's public key, which then associates the notes file and its encrypted file key with User B. The new encrypted file key for User B is then stored on the server (700). Thus, both User A and User B can retrieve and update the notes file.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing files, comprising:
sending by a user, to a server, a request for a file;
receiving, in response to the request, an encrypted file and an encrypted file key associated with the file and the user;
decrypting the encrypted file key using a private key associated with the user to obtain a symmetric key; and
decrypting the encrypted file using the symmetric key to obtain the file,
wherein the files being managed are server resident files for any number of users, and
wherein the server is unable to encode or decode file data associated with the server resident files.

2. The method of claim 1, further comprising:
obtaining an encrypted private key for the user;
decrypting the encrypted private key using a credential associated with the user to obtain the private key.

3. The method of claim 2, further comprising:
prior to decrypting the encrypted private key:
generating a hashed credential using the credential and a hash function; and
authenticating the user to the server using the hashed credential.

4. The method of claim 3, further comprising:
prior to generating the hashed credential, obtaining the credential from a computing device.

5. The method of claim 4, wherein the computing device is a smartphone or a tablet.

6. The method of claim 1, further comprising:
creating a new file by the user;
generating a second symmetric key for the new file;
encrypting the new file with the second symmetric key to obtain a second encrypted file;
obtaining a public key associated with the user;
encrypting the second symmetric key with the public key to obtain a second encrypted file key for the new file; and
transmitting the second encrypted file and the second encrypted symmetric key to the server.

7. The method of claim 1, further comprising:
receiving a request to grant a second user access to the file;
obtaining a public key associated with the second user;
encrypting the symmetric key using the public key to obtain a second encrypted file key for the file; and
transmitting the second encrypted file key to the server;

8. The method of claim 1, further comprising:
receiving an update for the file;
obtaining a snapshot of the file after receiving the update;
encrypting the snapshot using the symmetric key to obtain an encrypted snapshot; and
transmitting the encrypted snapshot to the server.

9. The method of claim 1, further comprising:
receiving an incremental update for the file;
encrypting the incremental update using the symmetric key to obtain an encrypted incremental update; and
transmitting the encrypted incremental update to the server.

10. A non-transitory computer readable medium comprising instructions, which when executed by a processor perform a method, the method comprising:
sending by a user, to a server, a request for a file;
receiving, in response to the request, an encrypted file and an encrypted file key associated with the file and the user;
decrypting the encrypted file key using a private key associated with the user to obtain a symmetric key; and
decrypting the encrypted file using the symmetric key to obtain the file,
wherein the files being managed are server resident files for any number of users, and
wherein the server is unable to encode or decode file data associated with the server resident files.

11. The non-transitory computer readable medium of claim 10, the method further comprising:
obtaining an encrypted private key for the user;
decrypting the encrypted private key using a credential associated with the user to obtain the private key.

12. The non-transitory computer readable medium of claim 11, the method further comprising:
prior to decrypting the encrypted private key:
generating a hashed credential using the credential and a hash function; and
authenticating the user to the server using the hashed credential.

13. The non-transitory computer readable medium of claim 12, the method further comprising:
prior to generating the hashed credential, obtaining the credential from a computing device.

14. The non-transitory computer readable medium of claim 13, wherein the computing device is a smartphone or a tablet.

15. The non-transitory computer readable medium of claim 11, the method further comprising:
creating a new file by the user;
generating a second symmetric key for the new file;
obtaining a public key for the user;
encrypting the new file with the second symmetric key to obtain a second encrypted file;
encrypting the second symmetric key with the public key to obtain a second encrypted symmetric key; and
transmitting the second encrypted file and the second encrypted symmetric key to the server.

16. The non-transitory computer readable medium of claim 11, the method further comprising:
receiving a request to grant a second user access to the file;
obtaining a public key associated with the second user;
encrypting the symmetric key using the public key to obtain a second encrypted file key for the file; and
transmitting the second encrypted file key to the server.

17. The non-transitory computer readable medium of claim 11, the method further comprising:
receiving an update for the file;
obtaining a snapshot of the file after receiving the update;
encrypting the snapshot using the symmetric key to obtain an encrypted snapshot; and
transmitting the encrypted snapshot to the server.

18. The non-transitory computer readable medium of claim 11, the method further comprising:
receiving an incremental update for the file;
encrypting the incremental update using the symmetric key to obtain an encrypted incremental update; and
transmitting the encrypted incremental update to the server.
